(19) United States
(12) Patent Application Publication
(10) Pub. No.: US 2014/0115492 A1
(43) Pub. Date: Apr. 24, 2014

(54) SYSTEM AND METHOD FOR TRANSPOSING AN EXTERNAL USER INTERFACE ON A MOBILE DEVICE

(71) Applicants: Mehdi Tehranchi, Potomac, MD (US); Cameron Tehranchi, Potomac, MD (US); Rachid Sijelmassi, Bethesda, MD (US)

(72) Inventors: Mehdi Tehranchi, Potomac, MD (US); Cameron Tehranchi, Potomac, MD (US); Rachid Sijelmassi, Bethesda, MD (US)

(21) Appl. No.: 13/843,502

(22) Filed: Mar. 15, 2013

Related U.S. Application Data
(60) Provisional application No. 61/648,941, filed on May 18, 2012.

(51) Int. Cl. G06F 3/0481

(52) U.S. Cl. CPC G06F 3/0481
USPC 715/747

(57) ABSTRACT

One example of the system and method described herein may be used to operate or otherwise interact with a device from a mobile device by transposing an external user interface of the device for presentation at the mobile device. For example, using a contactless communication protocol, the mobile device may obtain from the device a device property used to transpose the external user interface. The device property may indicate an identity of the device, a type of device, a type of user interface or elements of the user interface, and/or other information that describes the device. Based on the device property, the mobile device may present a user interface that can be used to control a function of the device. In this manner, the mobile device may provide a user with its own (transposed) version, which may be customized by the user, of the external user interface.

### CROSS REFERENCE TO RELATED APPLICATIONS

This application claims priority to U.S. Provisional Patent Application Ser. No. 61/648,941, filed May 18, 2012, which is hereby incorporated by reference herein in its entirety.

### FIELD OF THE INVENTION

The invention relates to providing a user interface on a mobile device, for example, to transpose a less capable user interface of another device, or e.g., for the sake of resolution, or for size, or for functionality, or for any other considerations.

### BACKGROUND OF THE INVENTION

Today, the ability to personalize interfaces to interact with some classes of devices lack customization aspects that best matches user needs. For example, a person with a visual impairment may not be able to read buttons or text that controls the interface of an external device, while more capable mobile devices allow the person to customize the interface to suit the person's needs (such as by configuring the interface to display larger fonts, perform text-to-speech, or other options suitable for the user).

### SUMMARY OF THE INVENTION

According to one aspect of the invention, to solve these and various additional problems associated with conventional interfaces, the system and method described herein may provide a mechanism to transpose an external user interface of the external device for presentation at a mobile device. Using the transposed external user interface, a user may use the mobile device to control a function of the external device. In some implementations, the transposed external user interface may be configured by the user according to user preferences.

Addressable external device can include a wide range of devices performing various functions such as, for example, a copier machine providing a copy function, a parking meter providing a ticket meter function, a vending machine providing various products, a coffee machine providing various coffee flavors, ATM machine at bank, or other types of devices performing various functions. In some implementations, the mobile device can include, for example, a cellular phone, a smart phone, a tablet computing device, a laptop computing device, or other generally portable device that can communicate with the external device.

In some implementations, the external device may detect a presence of the mobile device, establish a communication with the mobile device, and communicate device properties to the mobile device. Likewise, the mobile device may detect a presence of the external device, establish a communication with the external device, and receive device properties from the external device. Device properties may identify the device, identify a type of the device, and/or may provide specifications that describe user interface components of the external user interface.

In some implementations, the mobile device may use device properties to lookup or otherwise determine specifications of the external user interface. Based on the specifications, the mobile device may transpose the external user interface for presentation at the mobile device. For example, the mobile device may transpose the external user interface of a copy machine for presentation on the mobile device. The transposed external user interface may include copy options that, in some implementations, mimic or are otherwise analogous to native user interface components of the external user interface. In the copy example, the transposed external user interface may include a “copy” button that when selected at the mobile device initiates a copy job at the copier. When the mobile device receives an input value such as an indication that the “copy” button was selected, the mobile device may communicate the value to the external device, where upon receipt, the external device causes a function to be performed (such as initiating the copy job) based on the value.

In some implementations, the interaction between the mobile device and the external device may be indicated as secure. In these implementations, the mobile device may capture biometrics such as a photograph or a fingerprint that identify the user and may include the biometrics in the interaction record. In some implementations, the mobile device and/or the external device may generate the interaction record, which may include the biometrics.

Other objects and advantages of the invention will be apparent to those skilled in the art based on the following drawings and detailed description.

### BRIEF DESCRIPTION OF THE DRAWINGS

FIG. 1 illustrates an exemplary system for transposing an external user interface at a mobile device, according to various implementations of the invention.

FIG. 2 illustrates an exemplary method that may be used to transpose an external user interface of a device, according to various implementations of the invention.

FIG. 3 illustrates an exemplary method that may be used to provide a device property to a mobile device so that the mobile device may transpose a user interface of the device, according to various implementations of the invention.

FIG. 4 shows an embodiment of the invention, with main device detecting multiple devices.

FIG. 5 shows an embodiment of the invention, with the main device connecting to a user interface selector module.

FIG. 6 shows an embodiment of the invention, with the processor connecting to multiple users, through input modules.

FIG. 7 shows an embodiment of the invention, with low resolution and high resolution version libraries, or multiple resolution libraries.

FIG. 8 shows an embodiment of the invention, for a system similar to that of FIG. 2.

FIG. 9 shows an embodiment of the invention, for the device detection module being triggered by a trigger scheduler module.

### DETAILED DESCRIPTION

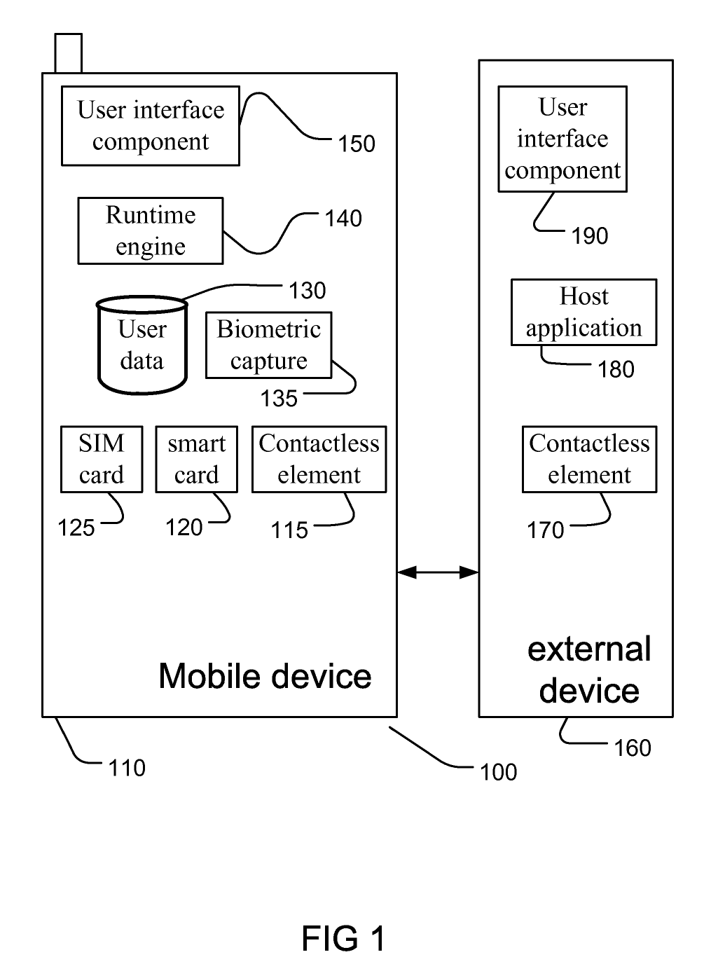

FIG. 1 illustrates an exemplary system 100 for transposing an external user interface of a device, according to various implementations of the invention. In some implementations, system 100 may be used to operate or otherwise interact with a function of the device from a mobile device by transposing the external user interface for use at the mobile device. For example, mobile device 110 may obtain from device 160 (used interchangeably with “external device”) a device property used to transpose the external user interface. The device property may indicate an identity of the device, a type of device, a type of user interface or elements thereof, and/or other information that describes device 160 such that mobile device 110 can transpose or otherwise interpret the external user interface for use at the mobile device. Based on the device property, mobile device 110 may present a user interface that can be used to control a function of device 160.

In this manner, mobile device 110 may provide a user with its own (transposed) version or implementation of the external user interface so that the user may operate device 160 using the mobile device. In some implementations, the transposed external user interface may be customized by the user at mobile device 110, allowing the user to configure the appearance or usability of the transposed external user interface. Furthermore, in some implementations, by managing the interaction between mobile device 110 and device 160, system 100 may also augment the interaction with security information, audit and accounting information, and/or other information for documenting the interaction.

In some implementations, device 160 may include a wide range of devices that provide various functions. For example, device 160 can be implemented as, without limitation, a copier machine, a parking meter, a vending machine, or other device that can receive an input to control a function.

In some implementations, device 160 may include a contactless element 170 (described in more detail with respect to mobile device 110) used to communicate with the mobile device. In some implementations, device 160 includes a host application 180, which can include instructions that configure a processor (not illustrated in FIG. 1) of device 160 to process inputs from user interface component 190 and interact with mobile device 110.

In some implementations, user interface component 190 may include mechanical inputs (e.g., mechanical buttons, switches, rockers, etc.) and/or electronic inputs (e.g., a display, a touch input surface, a touch screen that can display text, inputs, soft keys, etc.). In some implementations, the user interface of device 160 may include circuitry associated with the mechanical inputs and/or a graphical user interface associated with the electronic inputs.

Oftentimes, user interface component 190 may not be well suited for particular users. For example, a button of device 160 may be associated with text that is too small to read for a visually impaired user. Furthermore, device 160 typically lacks an ability to add accounting or audit trails (such as who commenced a copy job) or enhanced security (such as a verification of an identity of a user) when processing the functions of the device. As such, mobile device 110 may be configured to transpose the user interface of device 160 so that a function of the device can be controlled using the mobile device while, in some implementations, recording security, audit, or accounting information associated with an interaction between mobile device 110 and device 160.

In some implementations, mobile device 110 may include various devices such as, without limitation, a cellular phone, a smartphone, a tablet computing device, a laptop computing device, and/or other generally portable device that can communicate with device 160.

In some implementations, mobile device 110 may include a contactless element 115 that establishes a communication with a contactless element 170 of external device 160. Contactless elements 115, 170 each may include a wireless and/or radio transceiver implementing various protocols and standards such as BLUETOOTH, Near-Field Communication, and other communication methods that do not require physical contact for communication/interaction.

In some implementations, mobile device 110 may detect the presence of and establish communication with device 160 using contactless element 115. Likewise, in some implementations, device 160 may detect the presence of and establish communication with mobile device 110 using contactless element 170. Generally, though not necessarily, the communication established between contactless elements 115 and 170 is bi-directional. For example, in some implementations, contactless element 170 may be used to communicate a device property to mobile device 110 and contactless element 115 may be used to communicate an input value to device 160.

In some implementations, mobile device 110 may include a smart card 120, which may store information associated with a user of the mobile device. For example, smart card 120 may include payment information associated with a payment account of a user, encryption information for encrypting data, and/or other information. As such, mobile device 110 may use smart card 120 to provide payment information to device 160 for implementations involving a payment transaction.

In some implementations, mobile device 110 may include a Subscriber Identity Module (“SIM”) card 125 that can identify a user and be used between different mobile devices yet maintain an identity of the user. In this manner, mobile device 110 may use SIM card 125 to provide an identity of the user to device 160 for implementations where an accounting or audit trail of the interaction is generated.

In some implementations, mobile device 110 may include user data 130, which may be stored in a local memory or a remote memory accessible by mobile device 110 (e.g., via a network connection; the local memory, remote memory and network connection are not illustrated in FIG. 1). User data 130 may include user configurations such as preferences for the presentation or behavior of a transposed user interface at mobile device 110. For example, in some implementations, user data 130 may include user preferences that specify text-to-speech functions to read user interface options, font sizes or colors to be used when displaying text associated with the user interface, a mapping of any mechanical interface elements (such as mechanical buttons) of mobile device 110 to particular functions of the user interface, and/or other preferences of a user that can control the presentation or behavior of the transposed external user interface.

In some implementations, mobile device 110 may include a biometric capture device 135 used to determine an identification of a user. For example, in some implementations, the biometric capture device 135 may include a camera, a fingerprint scanner, or other device that captures a physical attribute of a user that can be used to identify the user. In some implementations, an output (e.g., a picture) of biometric capture device 135 may be used to provide authentication information for the interaction between mobile device 110 and device 160.

In some implementations, mobile device 110 may include a runtime engine 140 used to manage the interaction between the mobile device and device 160. Runtime engine 140 may, for example, include instructions such as a mobile application that configures a processor (not illustrated in FIG. 1) of mobile device 110 to receive from device 160 (via, e.g., contactless element 115) a device property, transpose the external user interface based on the device property, and present the transposed external user interface at the mobile device.

In some implementations, mobile device 110 may include a user interface component 150 that receives user inputs to control various user interfaces, including the transposed external user interface. For example, user interface component 150 may include mechanical inputs (e.g., mechanical buttons, switches, rockers, etc.) and/or electronic inputs (e.g., a display, a touch input surface, a touch screen that can display text, inputs, soft keys, etc.).

In some implementations, runtime engine 140 may “present” the transposed external user interface by transposing an input function associated with the external user interface to a mechanical input. For example, in implementations where device 160 includes a copier that displays a user interface having a “copy” input that initiates a copy function, runtime engine 140 may transpose the copy input to a particular mechanical button (or key) of the mobile device (e.g., the “5” mechanical button) such that when the user presses the “5” mechanical button on the mobile device, the copy function will be initiated. Other interface components of mobile device 110 may similarly be used to provide functions of the transposed external user interface (such as an input to specify a number of copies to be created at the copier).

In some implementations, different inputs of the external user interface may be transposed to different mechanical buttons of the mobile device. For example, where device 160 includes a vending machine having buttons corresponding to different products, runtime engine 140 may transpose a product choice onto a different mechanical button of the mobile device such that a mechanical button of the mobile device may correspond to one product while another mechanical button of the mobile device may correspond to another product.

In some implementations, runtime engine 140 may “present” the transposed external user interface by transposing an input function associated with external user interface to an electronic input. For the copier example, runtime engine 140 may cause a touchscreen to display a “copy” soft key such that when the user presses the “copy” soft key on the mobile device, the copy function will be initiated on the device 160.

In some implementations, the transposed external user interface may at least partially mimic or otherwise be made to resemble the external user interface. For example, runtime engine 140 may cause a touchscreen to display an array of soft keys having a similar shape, configuration, color, etc., and/or arranged in a manner similar to various buttons of a vending machine.

In some implementations, runtime engine 140 may “present” the transposed external user interface by transposing an input function associated with external user interface to both a mechanical input and an electronic input. For example, one input function of the external user interface may be transposed to a mechanical input of the mobile device while another input function may be transposed to an electronic input of the mobile device.

In an exemplary operation, a user wishing to operate device 160 may bring a mobile device 110 within proximity of device 160. Mobile device 110 may determine the proximity of device 160 (and/or vice versa) and a resulting communication may be established between the two devices. Device 160 may communicate a device property to mobile device 110. Based on the device property, mobile device 110 may transpose an external user interface of device 160 and present the transposed external user interface. The user may then make a selection using the transposed external user interface (e.g., by pressing a mechanical or soft button) and mobile device 110 may communicate the selection to device 160. Device 160 may cause the corresponding function to be processed. Mobile device 110 and/or device 160 may create an interaction record that documents the interaction. Mobile device 110 and/or device 160 may augment the interaction record by including in the record biometric or other security information obtained from the user or memory of mobile device 110 so that the interaction may be later verified as being legitimate. Mobile device 110 and/or device 160 may augment the interaction record by including in the record information about the interaction such as an identity of the user, which function was performed, a date of the interaction, and so forth.

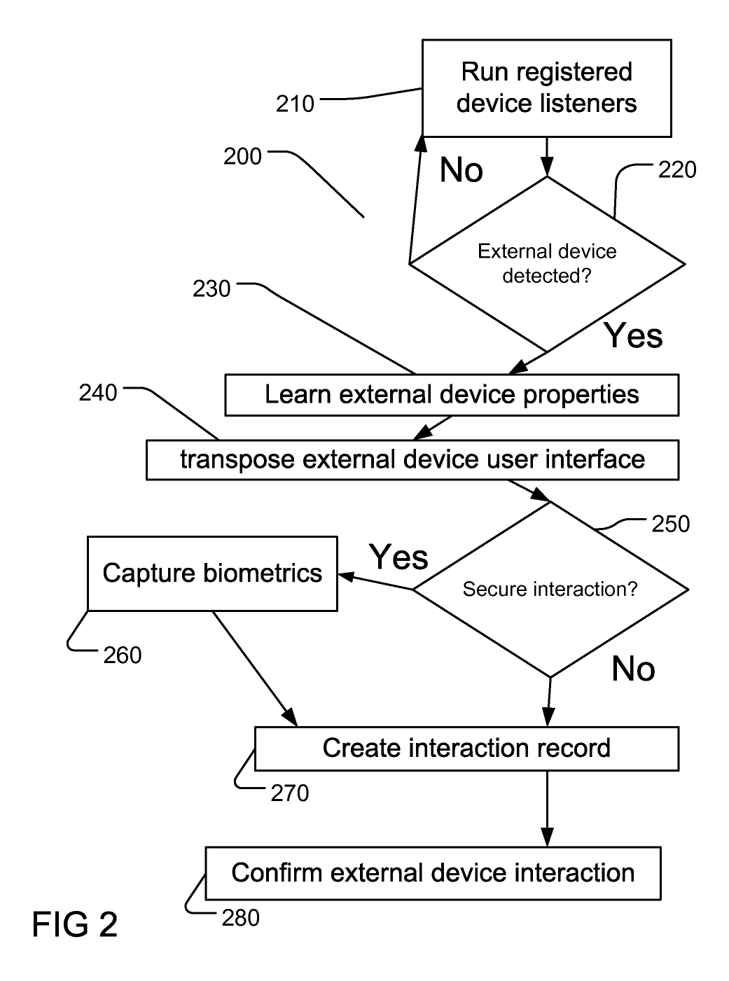

FIG. 2 illustrates an exemplary method 200 that may be used to transpose an external user interface of a device, according to various implementations of the invention. For example, in some implementations, method 200 may be performed by mobile device 110 to transpose the external user interface of device 160.

In some implementations of the invention, in an operation 210, method 200 may include running registered device listeners. For example, method 200 may periodically or at predetermined times attempt to discover device 160. In some implementations, different devices 160 may be registered in a repository to which the method has access such that method 200 is aware of the various devices whose external user interfaces may be transposed.

In some implementations of the invention, in an operation 220, method 200 may include determining whether device 160 has been detected. When device 160 is not detected, method 200 may return to operation 210. When device 160 is detected, method 200 may proceed to an operation 230.

In some implementations of the invention, in operation 230, method 200 may include establishing a communication with device 160 and learning an external device property via the established communication. For example, mobile device 110 may be placed within range/proximity of device 160 such that method 200 can establish a communication with device 160 and receive a device property from device 160.

In some implementations of the invention, the device property may include a device identifier that identifies the device (e.g., a particular device) or type of device (e.g., a “copier” or “parking meter”). In these implementations, method 200 may use the device identifier to lookup specifications of the device and in particular may use the device identifier to lookup a specification of a user interface input used to control a function of the device. The lookup may be performed locally (e.g., from a memory of mobile device 110) or remotely (e.g., via a query to a networked device such as a server that stores the device identifiers and specifications).

In some implementations of the invention, for example, a specification associated with a vending machine may define user interface buttons that each correspond to a different product as well as an inputs for money and prices, which can be used to transpose the user interface inputs onto mobile device 110.

In some implementations of the invention, the device property may directly include the user interface specification. For example, the device property may be transmitted in the form of a markup language (e.g., Extensible Markup Language) or other format that can specify fields and values corresponding to the user interface buttons and inputs of device 160. In this example, method 200 may parse the markup language to understand the various user interface inputs of the external user interface. In one embodiment, the device property is stored in a storage or removable storage unit(s).

Regardless of which implementation is used to determine user interface features associated with the device property, in an operation 240, method 200 may include transposing the external user interface based on the device property. In doing so, in some implementations, method 200 may refer to user preferences to present the transposed external user interface (such as by generating a soft key with a large font or reading user interface instructions using text-to-speech).

In one example, method 200 may assign a mechanical button or soft key to correspond to a product selection button and/or a money input of the vending machine such that the user may select a product or enter a money amount using mobile device 110 to obtain the selected product from the vending machine.

In another example, method 200 may assign a mechanical button or soft key to correspond to a copy button of a copy machine that starts a copy function such that a user may use mobile device 110 to start a copy job on a copier.

In yet another example, method 200 may assign a mechanical button or soft key to correspond to an input of a parking meter associated with adding more time to the meter such that a user may use mobile device 110 to add time to a parking meter.

In any of the foregoing examples, in some implementations, the soft keys may be generated such that they mimic or otherwise are made to resemble a shape, size, color, or configuration of the corresponding user interface inputs of the external user interface. As would be appreciated, the foregoing examples are for illustrative purposes only and should not be viewed as limiting. Other examples of devices and their interfaces may be transposed as disclosed herein.

In some implementations of the invention, in an operation 250, method 200 may include determining whether the interaction between mobile device 110 and device 160 should be secured. When the interaction does not need to be secured, method 200 may proceed to an operation 270, discussed below. On the other hand, when the interaction should be secured, method 200 may proceed to an operation 260, wherein the method may include capturing biometrics or other security information such as a password. For example, method 200 may include requesting the user to take a photograph or obtain a fingerprint imprint of the user. In other implementations, method 200 may simply retrieve such biometrics from a memory of the mobile device. Upon capture of the biometrics or other security information, method 200 may proceed to operation 270.

In some implementations of the invention, in operation 270, method 200 may include creating an interaction record. The interaction record may include a description of the transaction. The description may include, for example, an identity of the user, an identity of the mobile device, an identity of the device, a function of the device performed (e.g., vended a particular product, made a copy, added time to a parking meter, etc.), money/purchase exchange, or other information associated with the interaction between mobile device 110 and device 160. In this manner, the interaction record may serve as an accounting or audit trail. For example, instead of a user inputting a code into the copier to identify the user to start a copy job that requires a user identification, the user may present mobile device 110 such that method 200 logs who the user is and the copy job that was performed. In some implementations, method 200 may further augment the interaction record with other suitable accounting or auditing information as appropriate.

In implementations where biometrics were captured, method 200 may include the captured biometrics with the interaction record. For example, the interaction record may include biometrics of the user so that the interaction may be later verified by the user or other entity as being authentic. In some implementations of the invention, in an operation 280, method 200 may include confirming the interaction with the external device. For example, method 200 may display a confirmation message that the function was successfully performed at device 160.

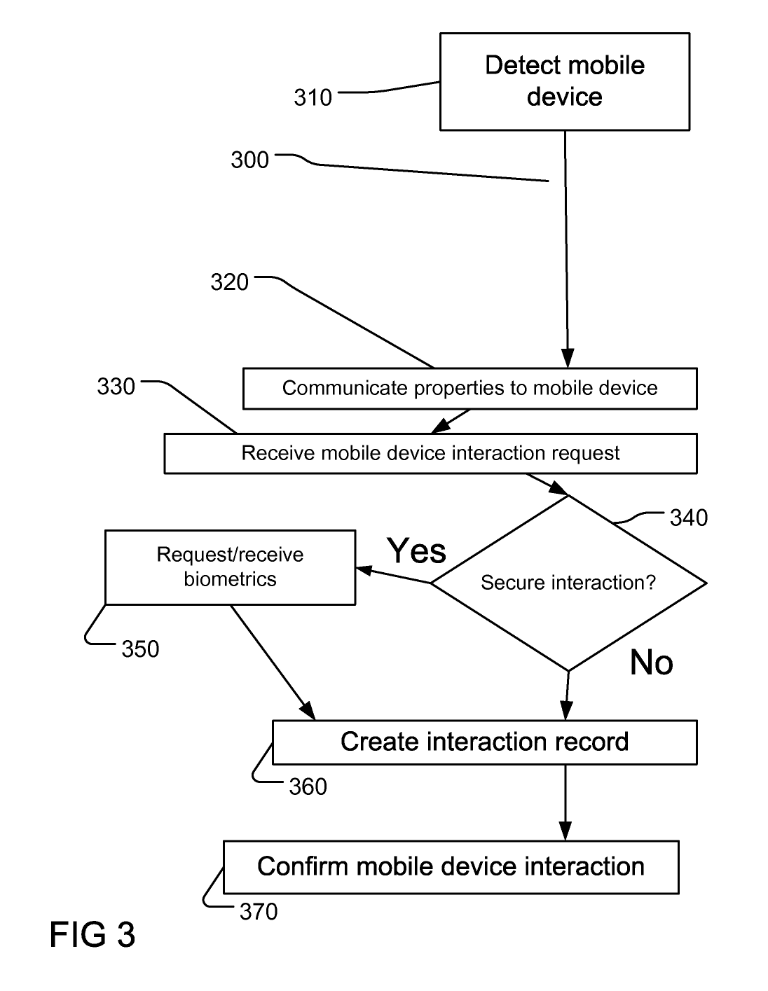

FIG. 3 illustrates an exemplary method 300 that may be used to provide a device property to a mobile device so that the mobile device may transpose a user interface of the device, according to various implementations of the invention. For example, in some implementations, method 300 may be performed by device 160 to provide a device property used by mobile device 110 to transpose the external user interface of device 160.

In some implementations of the invention, in an operation 310, method 300 may include detecting mobile device 110. In some implementations of the invention, in an operation 320, method 300 may include communicating a device property to mobile device 110. The device property may, as described above with respect to FIG. 2, identify device 160, identify a type of device, and/or describe a feature of the external user interface of device 160.

In some implementations of the invention, in an operation 330, method 300 may include receiving a mobile device interaction request. For example, method 300 may receive a request from mobile device 110 to perform some function associated with device 160. As such, method 300 may receive from mobile device 110 a value associated with the external user interface, which was transposed at the mobile device.

In some implementations of the invention, in an operation 340, method 300 may include determining whether the interaction between mobile device 110 and device 160 should be secured. When the interaction does not need to be secured, method 300 may proceed to an operation 360, discussed below. On the other hand, when the interaction should be secured, method 300 may proceed to an operation 350, wherein the method may include requesting and/or receiving from mobile device 110 biometrics or other security information such as a password. For example, method 300 may include requesting the user to take a photograph or obtain a fingerprint imprint of the user. Upon receiving the biometrics or other security information from mobile device 110, method 300 may proceed to operation 360.

In some implementations of the invention, in operation 360, method 300 may include creating an interaction record. The interaction record may include a description of the transaction. The description may include, for example, an identity of the user, an identity of the mobile device, an identity of the device, a function of the device performed (e.g., vended a particular product, made a copy, added time to a parking meter, etc.), money/purchase exchange, or other information associated with the interaction between mobile device 110 and device 160. In this manner, the interaction record may serve as an accounting or audit trail. In some implementations, method 300 may further augment the interaction record with other suitable accounting or auditing information as appropriate.

In implementations where biometrics were received from mobile device 110, method 300 may include the captured biometrics with the interaction record. For example, the interaction record may include biometrics of the user so that the interaction may be later verified by the user or other entity as being authentic. In some implementations of the invention, in an operation 370, method 300 may include confirming the interaction with the external device. For example, method 300 may communicate a confirmation to mobile device 110 that a function associated with the received value was complete and may display a confirmation message at device 160 associated with the completed function. A parking meter device, for example, may communicate to mobile device 110 that time was successfully added to the parking meter and may display at the parking meter the newly added time.

Here we have some examples for methods and systems of the invention:

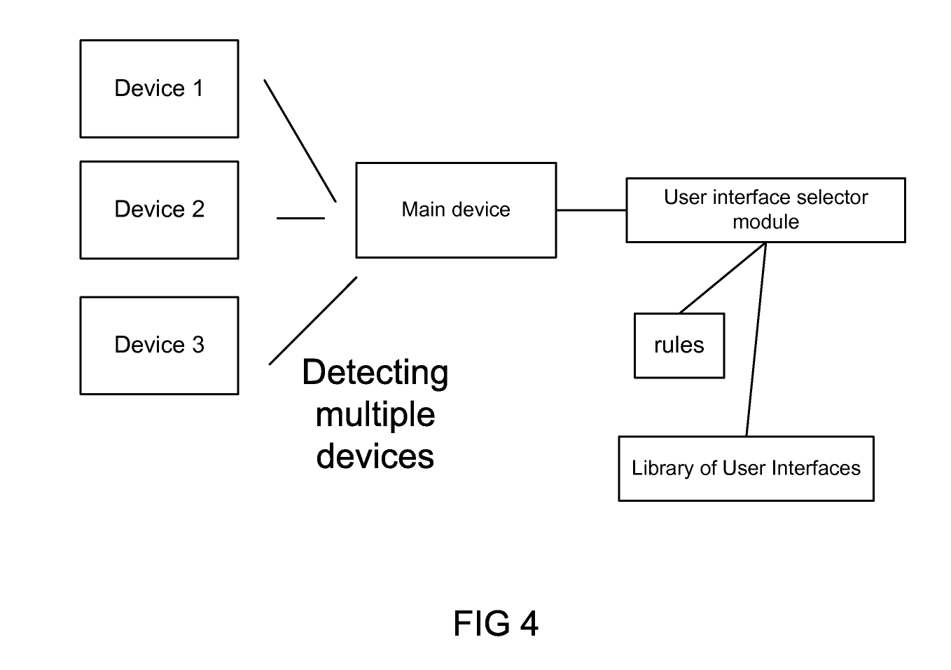

FIG. 4 shows an embodiment of the invention, with main device detecting multiple devices, and using an interface selector module, it can select proper user interfaces for each of the detected devices, in coordination with a rules engine and a library of user interfaces, which selects from the library available options.

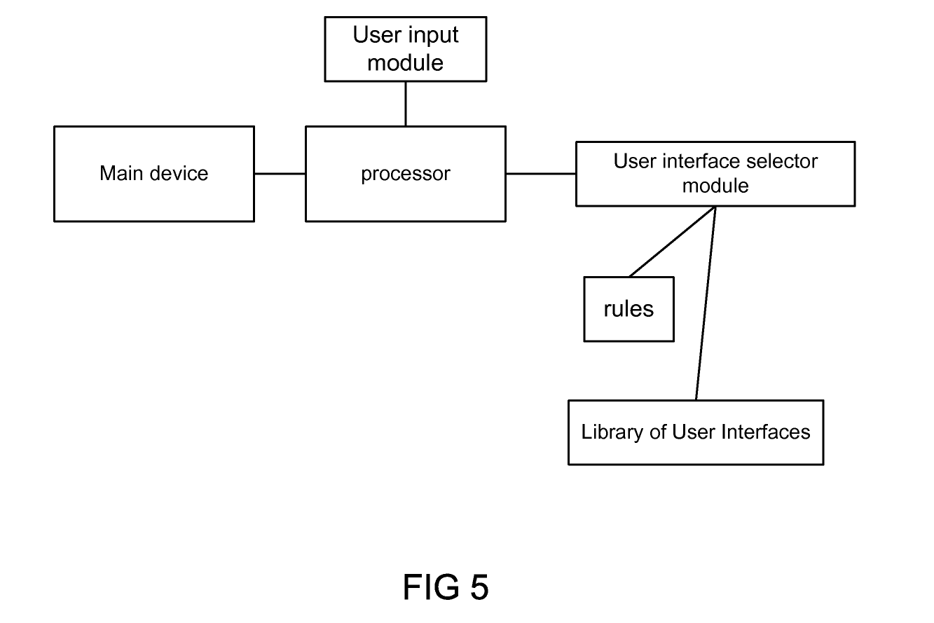

FIG. 5 shows an embodiment of the invention, with the main device connecting to a user interface selector module. In addition, a processor and user input module let the user influence or change the user interfaces or templates selected from the library of user interfaces.

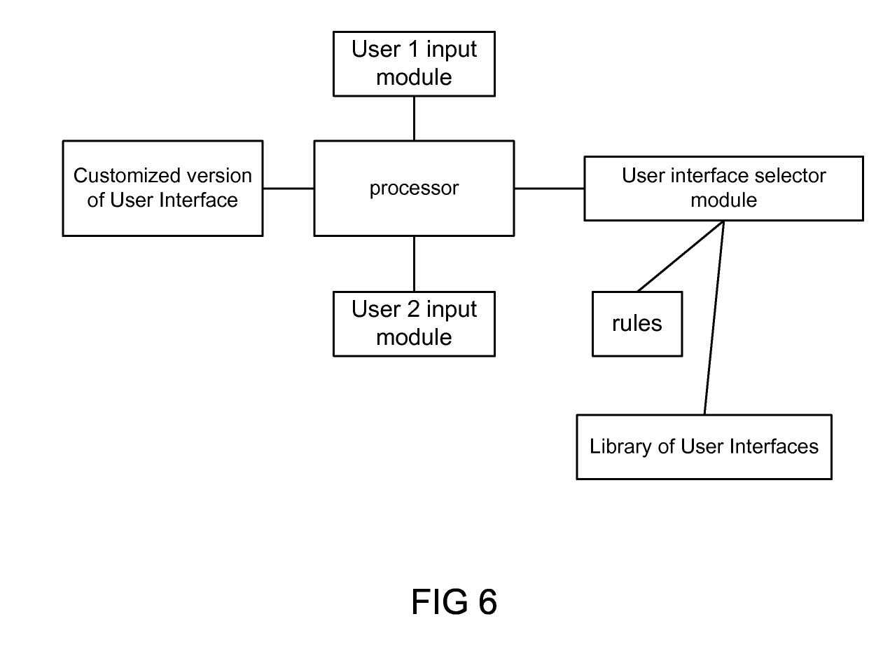

FIG. 6 shows an embodiment of the invention, with the processor connecting to multiple users, through input modules, with each user customizing his or her version of user interface for himself or herself, by manipulating the user interfaces or templates selected from the library of user interfaces.

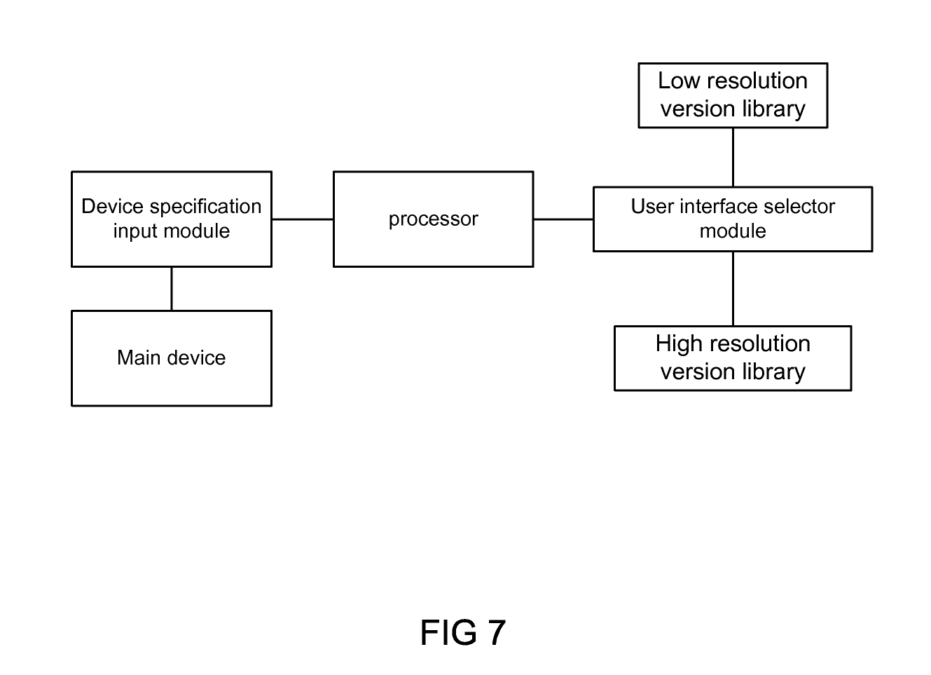

FIG. 7 shows an embodiment of the invention, with low resolution and high resolution version libraries, or multiple resolution libraries, which have different sizes and device requirements, which can be used for the corresponding devices, once they get detected by the main device, and then are classified or their parameters extracted, by device specification input module, to match with the appropriate resolution version of the same user interface, from the corresponding library.

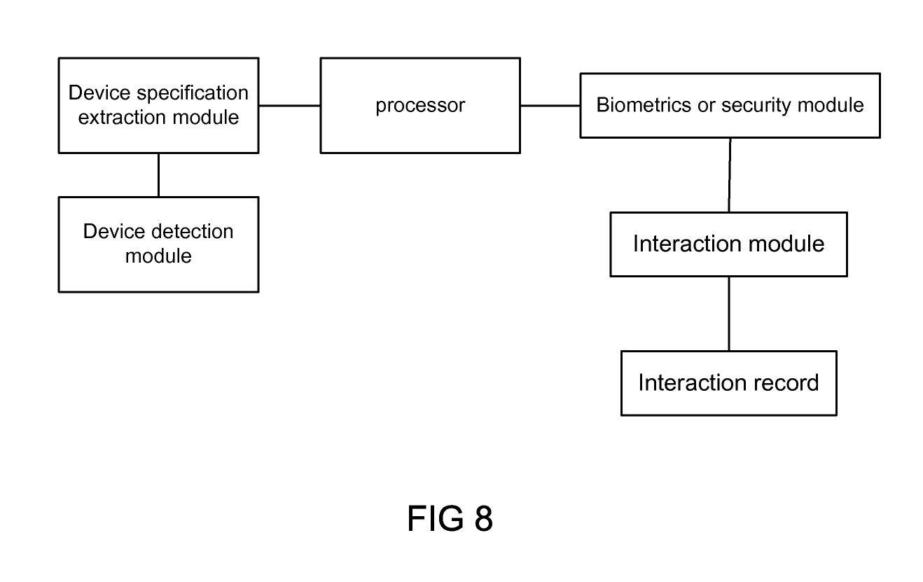

FIG. 8 shows an embodiment of the invention, for a system similar to that of FIG. 2, where the device detection module feeds device specification extraction module, to identify the device detected, and if the security or biometrics test is passed, the interaction is done, along with the creation of an interaction record.

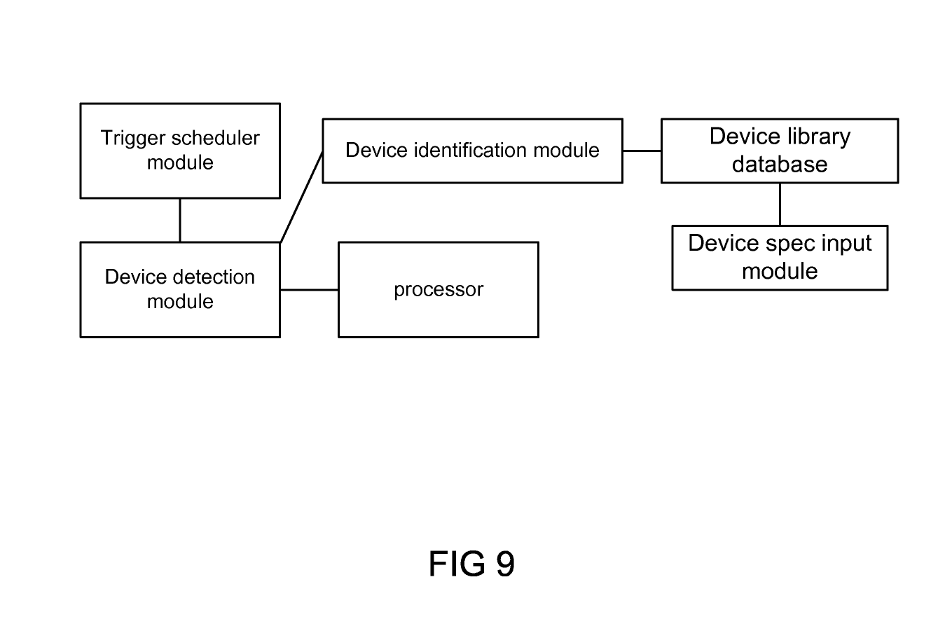

FIG. 9 shows an embodiment of the invention, for the device detection module being triggered by a trigger scheduler module, based on some periodic time or programmed schedule or the like. Then, it feeds the device identification module, which looks into the device library database to find a match for the detected device (Identify the device). The device library database also gets updated regularly by a device spec input module, from outside knowledgebase or experts.

Implementations of the invention may be made in hardware, firmware, software, or any suitable combination thereof. The invention may also be implemented as instructions stored on a machine-readable medium that can be read and executed on one or more processing devices. For example, the machine-readable medium may include various mechanisms that can store and transmit information that can be read on the processing devices or other machines (e.g., read only memory, random access memory, magnetic disk storage media, optical storage media, flash memory devices, or any other storage or non-transitory media that can suitably store and transmit machine-readable information). Furthermore, although firmware, software, routines, or instructions may be described in the above disclosure with respect to certain exemplary aspects and implementations performing certain actions or operations, it will be apparent that such descriptions are merely for the sake of convenience and that such actions or operations in fact result from processing devices, computing devices, processors, controllers, or other hardware executing the firmware, software, routines, or instructions. Moreover, to the extent that the above disclosure describes executing or performing certain operations or actions in a particular order or sequence, such descriptions are exemplary only and such operations or actions may be performed or executed in any suitable order or sequence.

Furthermore, aspects and implementations may be described in the above disclosure as including particular features, structures, or characteristics, but it will be apparent that every aspect or implementation may or may not necessarily include the particular features, structures, or characteristics. Further, where particular features, structures, or characteristics have been described in connection with a specific aspect or implementation, it will be understood that such features, structures, or characteristics may be included with other aspects or implementations, whether or not explicitly described. Thus, various changes and modifications may be made to the preceding disclosure without departing from the scope or spirit of the invention, and the specification and drawings should therefore be regarded as exemplary only, with the scope of the invention determined solely by the appended claims.

What is claimed is:

1. A method of interacting of a first device with a mobile device to control functions, with respect to user interface, said method comprising:
a first element on said first device detecting a presence of said mobile device;
said first device communicating with said mobile device;
said first device extracting a parameter characteristics of said mobile device;
wherein said parameter characteristics is related to a first user interface settings;
a processor receiving a second user interface settings;
said processor replacing said first user interface settings with said second user interface settings;
transposing said second user interface settings on display of said mobile device.

2. A method of interacting of a first device with a mobile device to control functions, with respect to user interface, said method comprising:
a first element on said first device detecting a presence of said mobile device;
said first device communicating with said mobile device;
said first device extracting a parameter characteristics of said mobile device;
wherein said parameter characteristics is related to a first user interface settings;
a processor receiving a second user interface settings;
said processor replacing said first user interface settings with said second user interface settings;
wherein said second user interface settings is based on rules engine.

3. A method of interacting of a first device with a mobile device to control functions, with respect to user interface, said method comprising:
a first element on said first device detecting a presence of said mobile device;
said first device communicating with said mobile device;
said first device extracting a parameter characteristics of said mobile device;
wherein said parameter characteristics is related to a first user interface settings;
a processor receiving a second user interface settings;
said processor replacing said first user interface settings with said second user interface settings;
wherein said second user interface settings is based on a library of user interfaces.

4. A method of interacting of a first device with a mobile device to control functions, with respect to user interface, said method comprising:
a first element on said first device detecting a presence of said mobile device;
said first device communicating with said mobile device;
said first device extracting a parameter characteristics of said mobile device;
wherein said parameter characteristics is related to a first user interface settings;
a processor receiving a second user interface settings;
said processor replacing said first user interface settings with said second user interface settings;
wherein said second user interface settings is based on a third party input.

5. A method of interacting of a first device with a mobile device to control functions, with respect to user interface, said method comprising:
a first element on said first device detecting a presence of said mobile device;
said first device communicating with said mobile device;
said first device extracting a parameter characteristics of said mobile device;
wherein said parameter characteristics is related to a first user interface settings;
a processor receiving a second user interface settings;
said processor replacing said first user interface settings with said second user interface settings;
wherein said second user interface settings is based on a customized user interface.

6. A method of interacting of a first device with a mobile device to control functions, with respect to user interface, said method comprising:
a first element on said first device detecting a presence of said mobile device;
said first device communicating with said mobile device;
said first device extracting a parameter characteristics of said mobile device;
wherein said parameter characteristics is related to a first user interface settings;
a processor receiving a second user interface settings;
said processor replacing said first user interface settings with said second user interface settings;
wherein said second user interface settings is based on resolution of templates or user interfaces library.

7. The method as recited in claim 1, said method comprising:
applying biometrics for identification of a user.

8. The method as recited in claim 1, said method comprising:
generating interaction records.

9. The method as recited in claim 1, said method comprising:
verifying secure interaction.

10. The method as recited in claim 1, said method comprising:
accessing SIM card.

11. The method as recited in claim 1, said method comprising:
applying smart card.

12. The method as recited in claim 1, said method comprising:
applying a contactless sensor or detector.

13. The method as recited in claim 1, said method comprising:
applying a payment transaction.

14. The method as recited in claim 1, said method comprising:
interacting with multiple devices.

15. The method as recited in claim 1, said method comprising:
prioritizing multiple devices.

16. The method as recited in claim 1, said method comprising:
providing different user interfaces for multiple devices.

17. The method as recited in claim 1, said method comprising:
ordering or ranking user interfaces.

18. The method as recited in claim 1, said method comprising:
hiding a user interface.

19. The method as recited in claim 1, said method comprising:
mimicking a user interface.

20. The method as recited in claim 1, said method comprising:
applying user interface to a parking meter.

21. The method as recited in claim 1, said method comprising:
applying user interface to an ATM or banking machine.

22. The method as recited in claim 1, said method comprising:
copying an arrangement of a user interface.

23. The method as recited in claim 1, said method comprising:
copying a color of a user interface.

24. The method as recited in claim 2, said method comprising:
applying biometrics for identification of a user.

25. The method as recited in claim 2, said method comprising:
generating interaction records.

26. The method as recited in claim 2, said method comprising:
verifying secure interaction.

27. The method as recited in claim 2, said method comprising:
accessing SIM card.

28. The method as recited in claim 2, said method comprising:
applying smart card.

29. The method as recited in claim 2, said method comprising:
applying a contactless sensor or detector.

30. The method as recited in claim 2, said method comprising:
applying a payment transaction.

31. The method as recited in claim 2, said method comprising:
interacting with multiple devices.

32. The method as recited in claim 2, said method comprising:
prioritizing multiple devices.

33. The method as recited in claim 2, said method comprising:
providing different user interfaces for multiple devices.

34. The method as recited in claim 2, said method comprising:
ordering or ranking user interfaces.

35. The method as recited in claim 2, said method comprising:
hiding a user interface.

36. The method as recited in claim 2, said method comprising:
mimicking a user interface.

37. The method as recited in claim 2, said method comprising:
applying user interface to a parking meter.

38. The method as recited in claim 2, said method comprising:
applying user interface to an ATM or banking machine.

39. The method as recited in claim 2, said method comprising:
copying an arrangement of a user interface.

40. The method as recited in claim 2, said method comprising:
copying a color of a user interface.
